(19) United States
(12) Patent Application Publication
(10) Pub. No.: US 2015/0000359 A1
(43) Pub. Date: Jan. 1, 2015

(54) COMPOSITION FOR INCREASING LITHIUM AND SELENIUM CONTENT IN VEGETABLES AND THEIR PROCESSED PRODUCTS AND USE THEREOF

(71) Applicant: Pier Giorgio Pifferi, Bologna (IT)

(72) Inventor: Pier Giorgio Pifferi, Bologna (IT)

(21) Appl. No.: 14/367,773

(22) PCT Filed: Dec. 20, 2012
(86) PCT No.: PCT/EP2012/076474

§ 371 Date: Jun. 20, 2014

(30) Foreign Application Priority Data
Dec. 23, 2011 (IT) BO2011A000759

(51) Int. Cl. C05D 9/02; C05D 5/00; C05D 1/00; C05F 11/00; C05F 1/00

(52) U.S. Cl. CPC C05D 9/02; C05F 11/00; C05F 1/007; C05D 1/00; C05D 5/00
USPC 71/15; 71/61; 71/11

(57) ABSTRACT

A composition provides increased. lithium and selenium content in vegetables and in their bio-technologically and/or technologically processed products. This composition comprises an aqueous solution of lithium compounds and selenium salts having a lithium content ranging from 0.0001 to 15.Og/l and selenium ranging from 0.0001 to 12.Og/l and at least an adjuvant selected among at least alkaline soap, chitosan hydrolysate, chitosan hydrolysate added with lecithin, and tannic acid and/or mixtures thereof where at least an adjuvant is assigned to increase the lithium and selenium ions absorption.

### TECHNICAL FIELD

The present invention relates to vegetables (fruits, tubers, horticultural and bulbs) treatments for increasing their nutritional value and the ones of their processed products (e.g. drinks, juices, conserves, extracts, etc. . . . ) in order to better promote human health.

In particular the object of the present invention is a composition for increasing primarily the nutritional quality of plants and their processed products by increasing lithium and selenium content: in fruit crops such as grapes, apples, pears, oranges, pomegranates, apricots, kiwi, cherries, sour cherries, olives, almonds, lemons, plums, in vegetable crops such as tomatoes, carrots, onions, chicories, artichokes, lettuces, potatoes, squashes, winter cauliflowers, spinaches, chards, fennels, asparagus, mushrooms, in herbs plants and spices such as arugula or salad rocket, rosemary, basil, sage, bay leaf, oregano, ginger, turmeric, thyme and at the same time for modulating and increasing the lithium and selenium absorption rate of the plant, by means of a composition containing adjuvants defined components, of natural origin and not produced by organic chemistry synthesis.

### BACKGROUND ART

It's well known that foods, especially plants, brings to human diet nutrients having functional properties for regulating biochemical processes and that are recommended for the good health promotion if assumed in the right doses.

LARN publications suggest a daily intake of 50 μg (micrograms) of selenium (Livelli di Assunzione Raccomandati di energia e Nutrienti per la popolazione italiana, edizione 1996).

Other publications suggest selenium as essential mineral to be taken in daily doses from 50 to 70 μg/day (committee on Dietary Allowances, Recommended Dietary Allowances, 11^{th} revised ed. U.S. GPO, Washington D.C., 1989).

It's well known and supported by epidemiological, pre-clinical and clinical studies, that selenium composites are strong chemo-preventive agents against cancer.

The selenium intake has been recognized as effective in reducing the tumours incidence, including prostate, lung, colon and liver cancer.

In addition the selenium incorporation in plants enhances the antioxidant activity of aqueous extracts as reported for green tea, rice, mushrooms, and it was also marketed a selenium enriched functional foods variety, such as garlic, yeast, green tea, seaweed, rice and potatoes, to provide selenium in human diet.

In addition to perform some fundamental biochemical functions, it seems that selenium has a precise role in reducing the radical concentrations in vitro and in vivo. Selenium is distributed in an uneven manner in foods and its concentration is very low in vegetables (from 0.010 to 0.020 μg/g) and fruits (from 0.002 to 0.018 μg/g), while it is present in meat (from 0.05 to 0.13 μg/g), grains (from 0.10 to 0.35 μg/g) and particularly in fish and shellfish (from 0.15 to 1.4 μg/g). Therefore the greater bio-integration of selenium forms present in plants, that are widely and extensively consumed, makes desirable to increase the small selenium quantities present thereof.

Micro-nutrients malnutrition leads to a spiral of increased disease susceptibility, disability and vital protection loss that leads to death (WHO, in the 2002 World Health Reports).

Among the 50 nutrients to be taken in adequate doses according to Welch and Graham (Field Crops Res 1999.60, p. 1-10) and in particular between the micro-nutrient other selenium also lithium is included as well.

Modern agriculture can contribute to increase micro-nutrients in foods through the fertilization agronomic practice.

The lithium should be taken from 0.60 to 3.1 mg in daily diet. This absorption depends on the production place of plant and on the food type consumed over a long time.

The lithium is located in the soil at a concentration of 0.065%, in flowing waters and minerals.

The lithium concentration knowledge in different foods is low, and highly variable depending on the nature and geology of the soil, it is more present in animal products (meat, milk, eggs) and in smaller quantities in tomatoes, mushrooms and potatoes.

The lithium is present in mineral waters in the order of mg/l, or rarely of some tens of mg/l and at least for certain areas, in, smaller contents in drinking water.

Nowadays worldwide research recommends lithium as micro-element because it is considered important for individual mental state and good humour and is also known to be antidepressant.

It has been shown that the places with the highest lithium concentration in drinking water tend to have lower individual depression rates and to develop less mental illnesses related to the brain cells degeneration.

Recently it has been discovered that human mortality rate is significantly lower in the municipalities where the drinking water contains more lithium.

Prof. Michael Ristow of Friedrich Schiller University in Jena confirmed in 2010, with research in collaboration with the Oita and Hiroshima University, that a small lithium concentration in the body seems to guarantee a longer life expectancy as found in an animal study model, the nematode “Caenorhabditis elegans” grown under the same low lithium concentrations.

Methods for increasing selenium in vegetables have been proposed in form of soil fertilization, and more rarely in form of foliar fertilization (tea, chicory, corn, potato).

The lithium administration to plants, order to increase its content, has not been proposed for any plant species.

Lithium and selenium co-administration by foliar way in plants to improve the nutritional quality and that of processed products obtained is not yet known.

In particular, it has never been proposed the joint administration of such micro-elements to a vegetable in order to assimilate them and to transfer to the edible portions (fruits, berries, tubers, kernels) and their processed products in varied proportions depending on the particular food obtained so as to satisfy defined nutritional requirements, or to obtain specific functionality in good health promoting.

To fully obtain these purposes it is considered convenient to use aqueous solutions of foregoing lithium and selenium salts, to sprinkle them over leaves, roots or parts of plants.

The sprinkling as foliar fertilization is a more effective method than the soil fertilization, because it uses smaller fertilizer quantities.

It's already well known as use and it better responds to specific consumer group nutritional needs and allows a more effective control of the plant and their edible portions.

### DISCLOSURE OF INVENTION

The main object of the present invention is to propose a chemical composition able to increase jointly the lithium and selenium content in fruit crops, in vegetable crops also in open fields, and industrial cereals crops, herbs and spices and to obtain also any processed products of their edible portions (drinks, juices, vinegars, preserves, extracts), enriched with said micro-elements having functional value.

Important object of the invention is also to provide a composition which, in addition to containing lithium ions and selenium salts, may also contains adjuvants components belonging to one of three different chemical species, and/or mixtures thereof, on one side compatible with the vegetable fertilization suitable for obtaining edible products defined biological or organic, and also able to improve the plant absorption rates of both sprinkled elements to obtain absorption rates greater than by spraying the plant with only aqueous solution, and therefore to reduce the absolute used salts contents, at the same concentration of mineral element obtained per vegetable weight unit.

Further object is to use a chemical composition in which the adjuvants components are natural origin compounds and with healthy potential valence for plant, and not produced by organic chemistry synthesis as occurs instead for other foliar fertilizer formulas or less found in patent literature, instead containing solvents such as dimethylsulfoxide, surfactants, polymers, chelating agents, obtained by chemical synthesis.

Desirable object, especially in certain short harvest cycle crops, it is to accelerate the lithium and selenium ions increasing in vegetables, improving the absorption kinetics with potential process accelerators, such as ascorbic acid in the invention composition, preferably in form of salified anion at pH from 7 to 9.0 with different alkaline cations and/or magnesium and/or zinc.

Further object is to propose an economic realization, easy to use and low environmental impacting chemical composition.

Another object of this invention is to achieve through lithium selenium minerals enrichment of the edible portion of the plant kept healthy until harvest and so at the highest appropriate degree, to the maintenance in the processed product (drinks, juices, vinegar, preserved, extracts, etc.) of micro-element enrichment.

It is therefore an object of the present invention a composition consisting of a solution comprising a mixture of aqueous solution with lithium compounds and selenium salts having lithium content from 0.0001 to 15.0 g/l (grams per litre) and selenium content from 0.0001 to 12.0 g/l with an aqueous solution of at least one among alkaline soap, chitosan hydrolysate, chitosan hydrolysate with lecithin, tannic acid and ascorbic acid where the elements of the latter solution are assigned to assist the lithium and selenium ions absorption, increasing it and/or making it faster.

### BRIEF DESCRIPTION OF DRAWINGS

The characteristics of the invention are highlighted in the followings with particular reference to the accompanying cartesian diagram drawings showing curves obtained by interpolation of experimental data wherein:

FIG. 1 shows the effect of associated adjuvants soap and chitosan-lecithin of the present invention composition about the lithium and selenium concentration increase into the vine grapes showed on a cartesian plane whose x-axes refers to the g (grams) of metal given to one hectare of field and y-axes refers to μg (micrograms + or −1) of selenium or lithium in 100 g of vine grapes grown in the field and where: the dash-dot line interpolating solid rhomboidal cartesian points represents the lithium concentration in grapes in presence of said adjuvants, the dashed line interpolating circle cartesian points represents the lithium concentration in grapes without adjuvants, the dash-dot-dot line interpolating solid squared cartesian points represents the selenium concentration in grapes in presence of said adjuvants, the continuous line interpolating triangle cartesian points represents the selenium concentration in grapes without said adjuvants and where coordinates of the cartesian points are obtained from on field experimental data.

FIG. 2 shows the reductive effect of associated adjuvants soap and chitosan-lecithin (alone or mixed) of the composition on the percentage of vines with grapes mould affected displayed on a cartesian plane whose x-axes refers to the adjuvants concentration as g/l (grams per litre) into the composition and y-axes refers to the percentage (+ or −1) of mould affected vine wherein: the horizontal dash-dot line interpolating solid rhomboidal cartesian points represents the affected vines percentage in not treated (absence of composition) vines, the dashed line interpolating circle cartesian points represents the affected vines percentage of lithium and selenium only treated field, the dash-dot-dot line interpolating solid squared cartesian points represents the affected vine percentage of treated field with the composition having soap as adjuvant, the continuous line interpolating triangle cartesian points represents the affected vine percentage treated with the composition having chitosan and lecithin (lecithin about 12% of chitosan) as adjuvants, the dashed line interpolating solid circle cartesian points represents affected vine percentage treated with the composition having soap, chitosan and lecithin as adjuvants and where cartesian points coordinates are obtained from on field experimental data.

FIG. 3 shows the effects of the composition comprising lithium, selenium, the above mentioned adjuvants and added with ascorbic acid on the lithium and selenium concentration increasing in the vine grapes displayed on a cartesian plane whose x-axes refers to time (in days after the treatment with 70 g/ha of lithium and 70 g/ha of selenium per field hectare) and y-axes refers to μg (+ or −1) of lithium or selenium for 100 g of vine grapes grown in said field and wherein: the dashed line interpolating triangular cartesian points represents the lithium concentration in grapes when the composition has lithium, said adjuvants and ascorbic acid, the dashed line interpolating solid circle cartesian points represents the lithium concentration in grapes without adjuvants into said composition the dashed line interpolating circle cartesian points represents the lithium concentration in grapes when the composition comprises lithium and said adjuvants without ascorbic acid, the continuous line interpolating triangular cartesian points represents the selenium concentration in grapes when the composition has selenium said adjuvants and ascorbic acid, the continuous line interpolating solid circle cartesian points represents the selenium concentration in grapes when the composition comprises selenium, ascorbic acid without adjuvants, the continuous line interpolating circle cartesian points represents the selenium concentration in grapes when the composition comprises lithium and said adjuvants without ascorbic acid.

### BEST MODE FOR CARRYING OUT THE INVENTION

In a preferred embodiment, the composition object of the present invention contains an adjuvant solution containing from 0.09 to 9.0 g/l of an active component selected among alkaline soap (S), chitosan hydrolysate linked to lecithin (CH-Le), or tannic acid (TA), in a volumetric ratio from 1:1 to 250:1 of salt solution to the adjuvant solution.

In the present invention composition the lithium compounds are preferably lithium salts selected among lithium acetate, bromide, carbonate, chloride, sulphate, selenite, selenate, nitrate, formate, citrate, sulfide, selenide and lactate, lithium salts of fatty fats from C4 to C26 saturated or unsaturated with 1-4 double bonds, lithium oxide, lithium hydroxide, litioamide, or metallic lithium in contact with water at room temperature.

The selenium salts are preferably selected among caesium, sodium, lithium, potassium, calcium, magnesium, barium, copper, zinc and ammonium selenites and selenates, which may be obtained from selenium dioxide by reaction with water and subsequent neutralization by means of sodium, potassium or lithium alkali hydroxides.

The adjuvants reference solutions are thus obtained and defined. The adjuvant S solution contains 9 g/l of soap and up to 9 g/l of citric acid. The soap is lithium, sodium, potassium soap, obtained from a mixture of an tallow and vegetable oil in a weight ratio of 1:1 wherein the oil can be seed oil and/or olive oil. The solution is obtained by dispersion of soap in drinking water or deionized water at 25° C. for sufficient time by stirring, bringing the final pH up to 9.0 with sodium carbonate or potassium or preferably lithium carbonate.

The chitosan hydrolysate solution is obtained dissolving 9.0 g of chitosan powder (deacetylation degree about 82%) in 18 g of acetic or formic or lactic or citric or malic or tartaric or gluconic or oxalic or hydrochloric or ascorbic or ethylenediaminatetraacetic (EDTA) acid and 0.70 l of deionized water or drinking water in glass container at 25° C. for one hour of continuous stirring. Then 0.050 l of 3% hydrogen peroxide are added to the viscous pass and are maintained under stirring for 72 hours, then is brought up to pH 6 with alkali and is rapidly added 1.2 g of soy lecithin dispersed in 8 per thousand aqueous solution. The solution volume is brought up to 11 with deionized water and pH up to 8.0 with alkaline carbonate.

The adjuvant solution TA is obtained by dispersion of 9.0 g of tannic acid in 1 l of drinking water to which up to 2.0 g of citric acid and 0.4 ml of ethyl citrate are added. The mixture is stirred and the pH is brought up to 7.5 with sodium or lithium carbonate.

The solution is thought to play a role in dispersing the hydrophobic tail of the fatty acids that can coordinate the selenite anion and also bind the lithium cation to the sold negatively load.

The hydrophobic tail can then spread in the waxy lipid surface film of the plant leaf, facilitating the ions passage through the pores of the plant cell membrane.

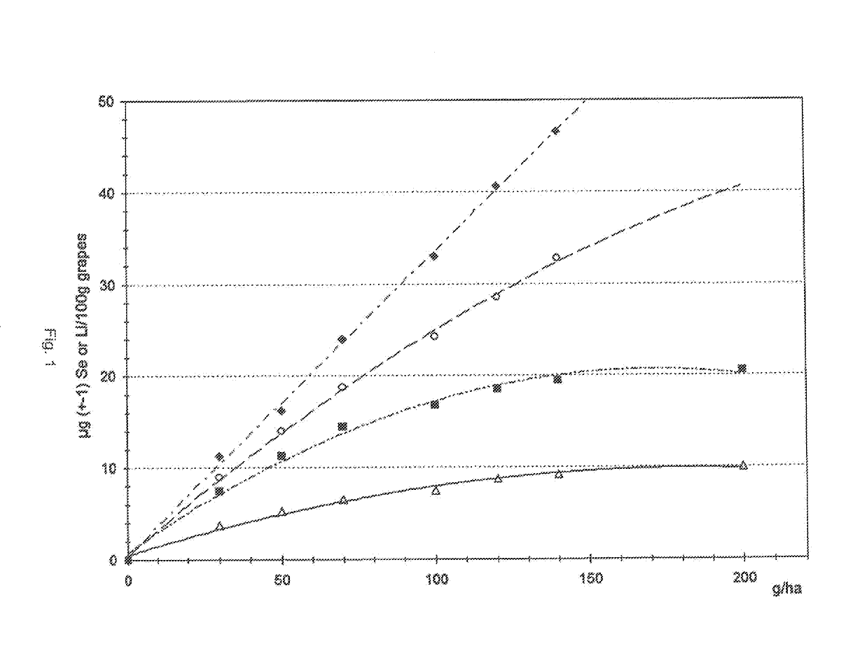

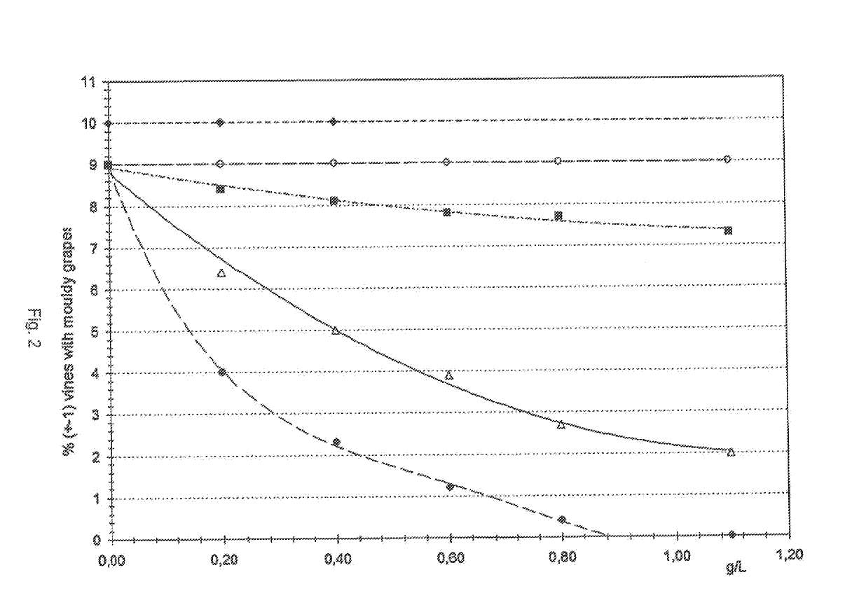

The chitosan hydrolysate (CH-Le) is constituted by oligomers having different molecular weight of glucosamine and/or acetylglucosamine, which can carry out a transport function for the electrostatic interaction with the selenite; perhaps have stimulating power not known (elicitor) for the enzymes and transport active hormones secretion. The chitosan lecithin oligomers micelles, due to the size of about from 300 to 500 nm, can include the selenite anion and the lithium cation and facilitate its transport across cell membranes thanks to the micelles amphiphilic behaviour. In the invention it is shown that the composition which contains alkaline soap and chitosan lecithin hydrolysate adjuvants increases simultaneously the lithium and selenium content per 100 g in the harvest fruit with respect to only the saline solutions, and this occurs for all lithium and selenium ions concentrations per hectare (1 hectare=1 ha=10000 m²) administered to the plant. This is totally unexpected but what is more surprising is the lithium increasing strongest than the selenium increasing, if these increasing as a result of adjuvants in the mixture are expressed on the basis of μg/atom mass per 100 g of vegetable. The increasing is much stronger for lithium than for selenium as if lithium interacts more with the adjuvants with respect to selenium, hardly predictable at chemical level (see FIG. 1 and example 5). Moreover, the two adjuvants association showed a protection preventive effect for product enriched (edible part) with respect to mould, significant and synergistic (see FIG. 2 and example 6). The tannic acid (TA), which has a phenolic rings number above and under the glucose molecule as a seat, as well as very soluble, may perhaps have chelating power towards the selenite anion and interact with the many water molecules coordinated to the lithium cation, favouring the membrane transport of both. The chemical species with an accelerating function of the lithium and selenium absorption kinetics by the plant has been unexpectedly detected in acid ascorbic, but for reasons of chemical stability it is preferably used in the form of lithium, sodium, potassium, magnesium, zinc salts and at pH from 7 to 9, and values ranging from 0.01 to 40 g/l in the composition. It is assumed that the ascorbate anion acts as “pioneer” for lithium and selenium ion in plant penetration through the membrane by an unknown mechanism. It does not appear that ascorbic acid has been used so far for lithium and selenium administration in plants with such a function.

The water of said composition can be distilled, deionized or drinking, and the composition may be administered to the plant in common use fertilizer combination or less such as nitrogen, phosphorus and/or potassium salts and supplements such as, for example, gluconates, EDTA or zinc, iron, copper salts.

The preparation may be sprayed preferably at a pH from 4.5 to 9, at temperatures from 5 to 40° C. in the form of small droplets of less than 0.025 mm on the plants hypogenous and epigeous, apparatus for a content up to 750 g of lithium and up to 600 g of selenium per hectare, and in particular on the leaves.

Spraying the composition on plants can be repeated several times during the growing season for values from about 400 to about 1000 l/ha.

Further details become dear from the description of some preferred embodiments of the composition for the treatment according to the present invention and the following are not limiting examples.

### EXAMPLE 1

Three crops, two of Trebbiano white and Sangiovese black grapevine and cherries are treated by means of spraying aqueous solutions containing 0.10 g/l of lithium (50 g/ha) and 0.060 g/l of selenium (30 g/ha).

The treatment is repeated as soon as flowering ends and after 20 days.

At harvest time the treated fruits showed a lithium content of 350-330-290 μg /Kg respectively for the Trebbiano white grapes, Sangiovese black grapes and cherries and higher than 12-11-9 times with respect to the reference.

The selenium content was 38-42-36 μg/Kg, respectively higher 9.5-8.8-12 times than the reference.

The treatment with the salts aqueous solution (50 l) added with 10 l of standard adjuvant S, or CH-Le, or TA solutions has resulted in an increase of the lithium content higher than 1.3-1.4-1.3 times with respect to the only salts solutions; the selenium content increasing was respectively 1.9-2.1-1.6 times with respect to the salts solutions.

It's evident an effective role of adjuvants and especially CH-Le and S is increasing absorption rates of both ions and especially selenium, and completely unexpected for those values.

1 kg of cherries obtained by treating plants with the solution of the salts added with adjuvant CH-Le solution in volume ratio of 5:1, harvest and pitted and containing 36 μg/kg of selenium and 93 μg/kg of lithium, are homogenized, added with 0.10 l of 4% pectin solution and then mixing 0.45 kg of sucrose. The mass is heated up to 50° C., is stirred and is concentrated in small vacuum boule up to 65 Brix degrees. The obtained jam contained 91 μg/kg of lithium and 32 μg/kg of selenium.

### EXAMPLE 2

A Gotturnio cultivar grape is treated with an aqueous solution containing 0.05 g/l of lithium, as lithium acetate (25 g/ha of lithium), and 0.15 g/l of selenium (75 g/ha), as sodium selenite. The treatment has been repeated at a distance of 20 days, and the second at a distance of 50 days from the grape harvest.

The berries presented, with respect to the reference, a lithium content of 155 μg/Kd that is 6 times higher and 88 μg/kg of selenium, 16 times higher. The obtained values with salts solutions added with adjuvants solutions with lithium soap S, or chitosan hydrolysate (CH-Le) or tannic acid (TA) in the ratio 10:1 v/v, were 1.80-1.90-1.6 times higher for selenium and respectively 1.25-1.4-1.15 times higher for lithium with respect to the tests without adjuvant.

On a convenient mass of grapes (1 t) resulting from the treated plots, was obtained after destalking a value of 168 μg/kg of lithium and of 91 μg/kg of selenium.

The mass of the stalked grape of 0.96 t was divided in half: the first part was subject to the mashing and after the addition of potassium metabisulfite (0.05% w/w) was fermented with yeast for six days until total depletion of sugar and then centrifuged. The must contained 155 μg/Kg of lithium and 58 μg/kg of selenium, while the vine had 145 μg/Kg of lithium and 28 μg/Kg o selenium that is about 7 times the selenium and 5 times the lithium of the reference wine.

The second half of the grape is subjected in sequence to the operations of crushing, extraction of the juice in screw extractor sieve, so as to retain the skins and seeds, venting, flash-pasteurizing, cooling and aseptic packaging.

The grape juice at 23° refractometric degrees contained 150 μg/Kg of lithium and 68 μg/kg of selenium.

The loss in selenium is mainly due to the fact that the skins removed contain 132 μg/Kg of selenium against the 75 μg/Kg of pulp.

The juice has anyway a value of selenium 17 times higher than untreated grape which has 4 μg/Kg and a value of lithium 4 times higher than untreated grapes.

Therefore, the effect of foliar fertilization for improving health largely remains even after the technological process both in the case of the grapes processed product to vine and to juice.

The lithium drops very little since it presents no volatility at pH 3.5 of the fruit, instead selenium loss is due to yeast capture and volatility at acidic pH.

### EXAMPLE 3

Over an extensive onions, carrots and potatoes crops some aqueous solutions of lithium chloride and sodium selenite are applied, containing 0.80 g/l of lithium and 0.40 g/l of selenium with administration of 500 l/ha.

There is an increasing in the concentration expressed as μg/Kg of 16-12-8 times for lithium and of 14-12-9 times for the selenium with respect to reference for onions, carrots and potatoes.

If it is used salts aqueous solutions added in volumetric ratio of 20:1 with the solution of S-based adjuvant potassium soap, or adjuvant CH-Le or tannic acid (TA), it can be obtained an increasing of 1,3-1,4-1,4, times of lithium and 1.8-2.0-1.6 times of selenium with respect to reference salts aqueous solutions.

The adjuvants minor effect on the lithium absorption is probably due to the fact that lithium is strongly coordinating with water; instead it is unexpected the constant significant increasing of selenium absorption especially with the adjuvants S and CH-Le, which reflects a complex biochemical effect difficult to predict and to understand in its mechanism.

### EXAMPLE 4

A rocket and a chicory greenhouse production of 1000 m² each are treated with a lithium nitrate aqueous solution containing 0.06 g/l of lithium and sodium selenite containing 0.04 g/l of selenium. The first treatment 8 days after germination is repeated after 8 days for the rocket and after 20 days for chicory. The volume of solution sprayed is 400 m³/ha, with a value of 24 g/ha of lithium and 16 g/ha of selenium,

At harvest, after 25 days for the rocket and after 125 days for the chicory, there is an increasing in the edible part of the lithium content of respectively 4 and 6 times with respect to the reference; the selenium increasing is 3 times for the rocket and 5 times for chicory.

The treatment with the salts aqueous solution added in the volumetric ratio of 40:1 of adjuvants S potassium based soap, or of adjuvant CH-Le, tannic acid TA resulted in an increasing compared to the reference, of 5-6-5 times for lithium and 8-9-7 times for selenium in the rocket; 8-8-7 times for lithium and 9-10-8 times for selenium in chicory, always referring to the edible part.

Remains the effectiveness of adjuvants and especially for the selenium absorption up to duplicate the result obtained with the only salts solution.

### EXAMPLE 5

A Salamino black grape cultivar vineyard of 1 ha with 3876 plants/ha is divided into 40 plots, each measuring 250 m2. The plants are spaced each other of 1.1 m along the row of 96 plants, and of 2.4 m between each row,

The plots 1-3-5-7-9-11 are each subjected to spraying with 25 l of a lithium and selenium salts aqueous composition at a concentration respectively of 30-50-70-100-120-140 g/l.

The plots 17-19-21-23-27-29 are sprayed with an equal composition of the salts but also as the first adjuvant containing lithium soap at 0.25 g/l and also as another adjuvant the chitosan-lecithin hydrolysate at concentration of 0.40 g/l. The treatment was carried out respectively at 75 days and the second at 50 days before grapes harvest.

FIG. 1 shows the μg of lithium and selenium absorbed by 100 g of Salamino black grapes with respect to the lithium and selenium concentrations administered per hectare.

It can be note the effect of the 2 adjuvants which determine the simultaneous significant increasing in the percentage quantities of ions absorbed compared to the only salt solutions without adjuvants. There is an increasing almost constant for all doses of about 1.40 times for lithium and completely unexpected of 2.15 times for selenium by effect of adjuvants association, but quite different in profile. The absorption mechanism appears more complex than for selenium whose absorption soon reaches saturation, but for which is more evident even if unexpected to that value the adjuvants role. The lithium absorption is dose-dependent of administered salt as revealed by the almost straight line of the graph and is apparently less affected by adjuvants as if lithium penetrates more due to aspects linked to the concentration increasing than that the interaction with adjuvants.

However, if it is considered the absolute increasing expressed at atomic level, understood as the increasing expressed in pg divided by element atomic weight, the lithium absolute increasing from 0.36 to 2.6 μg/atom (from 2.5 to 14 μg of percentage increasing), is higher than that of selenium from 0.047 to 0.13 μg/atom (from 3.7 to 10 μg of percentage increasing). This unexpected result confirms that adjuvants play an important role in increasing the selenium and lithium absorption, with higher selectivity for lithium, although difficult to interpret.

### EXAMPLE 6

It was investigated whether adjuvants have effect in maintaining the edible product of enriched vegetable healthy during the enrichment phase, and therefore maximize the effect of the invention also in the storage and/or transformation phrase.

On 1 ha of Salamino vineyard have reserved 16 plots of 500 m² each containing 192 plants, the treatment of spraying with a composition of the same solution of lithium and selenium salts respectively 50 g/ha of lithium and 70 g/ha of selenium in 1000l, using 50 i per plot. A plot was without adjuvants, 5 plots were sprayed with composition at increasing concentrations of 0.20-0.40-0.60-0.80-1.10 g/l of lithium soap adjuvant, while for other 5 plots the adjuvant was chitosan-lecithin at the same increasing concentrations. Finally, for another 5 plots the two adjuvants were associated in the composition of the lithium and selenium salt solution, each with above mentioned increasing concentrations.

On 5 October and 8 Oct. 2012 rains delayed the harvest up to 16 October. The harvest shown that compared to the reference plot without treatment, showing that about 10% of vines with grapes affected by mold, the plot with the treatment of alone lithium and selenium salts solution had about 9% of vines with some grapes contaminated. In the 5 plots sprayed with the same salt solution added with lithium soap adjuvant at content of 0.20-0.40-0.60-0.80-1.10 g/l, it is noted a slight decreasing of the vines contaminated that reduced to about 7% and going down instead to 2% if it is present in the composition only chitosan-lecithin adjuvant. The association of the two adjuvants in equal concentration and increasing for the 5 plots from 0.40 g/l to 2.20 g/l of total content of adjuvant, showed absence of contamination of the vines for the plot with value equal to the sum of adjuvants of 0.80 g/l and also a discrete synergistic effect of adjuvants.

Therefore, the use of only chitosan-lecithin adjuvant and in combination with the soap adjuvant shows, during the lithium and selenium increasing phase, a significant preventive effect in order of the integer maintaining the edible part of the plan t susceptible for processing, and maximizes the content of lithium and selenium enriched obtainable product.

### EXAMPLE 7

On 4 plots of 250 m² each planted with Salamino black grape with 192 plants per plot proceed spraying with 25 l of a composition containing 0.70 g/l of lithium and 0.70 g/l of selenium and potassium ascorbate in 1.5 g/l, at pH of 8.3 of the composition. On other 4 plots of 250 m² it is sprinkled the composition described but which also contains the two adjuvants soap and chitosan-lecithin hydrolysate each at a concentration of 0.20 g/l.

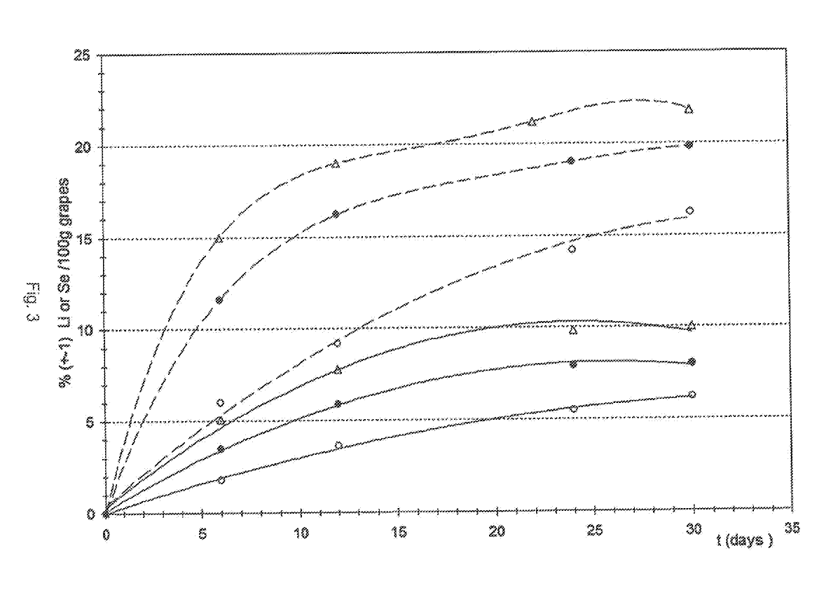

At four determined times representative samples of grapes are taken, equivalent to about 1% of weight of the total grape plot, on which are performed analysis of lithium and selenium in comparison with samples of grape vines plot not treated with the solution containing the potassium ascorbate. Is denoted by t/2 the time for which it reaches in the vegetable concentration equal to half the maximum concentration reached at the final plateau in long times. It is noted from the graph of FIG. 3 an increasing of absorption rate more marked for lithium with a t/2 of about 5 days to obtain the plateau for lithium in the presence of ascorbic acid accelerator against the 12 days of lithium of the alone salts composition, while for the selenium t/2 is 7 and 10 days respectively with and without the accelerant. In the presence of ascorbic acid and the two adjuvants the value of t/2 is 3.5 days for the lithium and 6 days for the selenium. It also highlights (see FIG. 3) a small effect of ascorbate on increased absorption rate of lithium and selenium. It has therefore about a halving of the time needed to reach a preset value of the lithium and selenium concentration in vegetable, especially useful for plant varieties in short development cycle such as those grown in the greenhouse.

1. Composition for increasing lithium and selenium content in vegetables and their biotechnologically or technologically processed products, comprising:
an aqueous solution mixture of lithium compounds and of selenium salts with a lithium content ranging from 0.0001 to 15,Og/l and selenium content ranging from 0.0001 to 12,Og/l and at least an adjuvant selected among at least an alkaline soap, a chitosano-lecithin hydrolysate, a tannic acid and/or a mixture thereof wherein the at least an adjuvant is assigned to increase the lithium and/or selenium ion absorption.

2. Composition according to claim 1, wherein the aqueous solution comprises an alkaline soap and the chitosan hydrolysate added with lecithin (CH-Le), as adjuvant.

3. Composition according to claim 1, wherein each selected adjuvant is present in the aqueous solution at a concentration ranging from 0.036 to 4.5 g/l at a composition pH ranging from 4.5 to 9.0.

4. Composition according to claims 1, wherein said lithium compounds are lithium salts selected among acetate, bromide, carbonate, chloride, sulphate, selenite, selenate, nitrate, formate, citrate, lactate, sulfide, selenide of lithium salts, and/or lithium salts of saturated or unsaturated fatty acids from C4 to C26 with 1-4 double bonds, or lithium oxide, lithium hydroxide, amide lithium, and metallic lithium put in contact with water at room temperature alone or mixed thereof.

5. Composition according to claim 1, wherein characterized in that said selenium salts are selected among selenites and selenates of lithium, of ammonium, of sodium, of potassium, of calcium, of caesium, of magnesium, of copper, of zinc, of barium alone or mixed thereof.

6. Composition according claim 1, wherein the adjuvant is soap of lithium, of sodium, of potassium, of magnesium alone or mixed thereof.

7. Composition according to claim 6, wherein the adjuvant in soap form is obtained from a mixture of animal tallow and of vegetable oil in a weight ratio 1:1.

8. Composition according to claim 2, wherein the chitosan adjuvant added with lecithin is constituted of oligomers type chitosan hydrolysate having less than 10 units of glucosamine and/or of acetyl-glucosamine, added with lecithin equal to about 13 weight of chitosan and added with lithium alkaline carbonate preferably up to bring the composition at pH of about 8.0.

9. Composition according to claim 1, wherein the adjuvant is tannic acid with a high purity degree added to aqueous solution at pH of about 7.0.

10. Composition according to claim 1, comprising being a mixture of an aqueous solution of lithium and selenium salts with an aqueous solution of adjuvant selected of about 9 g/l concentration, in volumetric ratio ranging from 250:1 to 1:1, with adjuvant final concentration in the composition ranging from 0.036 to 4.5 g/l.

11. Composition according to claim 1, further comprising an absorption accelerator of said lithium and selenium ion identified as ascorbic acid.

12. Composition according to claim 11, wherein the lithium and selenium ions absorption accelerator of the vegetable is ascorbic acid preferably in form of its salts of lithium, of sodium, of potassium, of magnesium, of zinc at a composition concentration ranging from 0.001 to 4 g/l, at pH ranging from 6.0 to 9.0.

13. Composition according to claim 1, comprising having a pH ranging from to 4.5 to 9.0.

14. Use of the composition according to claim 1, comprising sprinkling vegetables or fields with the composition to increase lithium and selenium content and/or to improve their absorption rate and to transfer all or a part of such enrichment from edible portions, consisting of berries, fruits, olives, tubers, leaves, bulbs, to their products of biochemical, fermenting and/or technological processing.

15. Use of the composition according to claim 14, comprising using the composition to treat vegetable fruit selected among grapes, pears, apricots, cherries, apples, kiwi, oranges, pomegranates, almonds, hazelnuts, plums, figs, olives, lemons, peaches, vegetable species selected from carrots, potatoes, tomatoes, onions, squash, eggplant, broccoli, cauliflower, fennel, mushrooms, garlic, artichokes, asparagus, spinach, lettuce, chicory and generally leafy vegetables, industrial crops oil selected among olive, sunflower, rapeseed and cereals, such as wheat, barley, corn, sorghum, oats, rice, herbs and spices selected among salad rocket, rosemary, basil, sage, bay leaf, oregano, thyme, ginger, turmeric.

16. Use of the composition according to claim 14, comprising using the composition at a pH ranging from 4.5 to 9.0 by vegetables foliar sprinkling.

17. Use of the composition according to claim 14, comprising using the composition for lithium and selenium enrichment in the edible portions of vegetables for the production of fermented or not beverages, such as wine, vinegar, balsamic vinegar, fruit juice or conserve, aqueous, oily, hydro alcoholic extracts or oil.

18. Use of the composition according to claim 14, comprising sprinkling the composition with a lithium content ranging from 0.001 to 750 g/ha and selenium ranging from 0.001 to 600 g/ha to increase the content and/or the absorption rate of lithium and/or of selenium in vegetables.

19. Use of the composition according to claim 14, comprising sprinkling the composition directly over the vegetable products after their harvesting at least for lithium and selenium enrichment.

20. Use of the composition according to claim 14, comprising using the composition comprising the combination of soap with chitosan-Iecthin to protect the edible portion of the vegetable from the mould attack in the enrichment step until harvesting.

21. Use of the composition according to claim 14, comprising using the composition comprising the ascorbate anion with or without adjuvant or mixtures thereof to increase absorption rate by vegetables.
